(19) United States
(12) Patent Application Publication
(10) Pub. No.: US 2026/0296251 A1
(43) Pub. Date: Oct. 1, 2026

(54) CHARGER, VEHICLE, AND AUTHENTIFICATION SERVER FOR PERFORMING CHARGING AUTHENTIFICATION USING DIGITAL KEY

(71) Applicants: Hyundai Motor Company, Seoul (KR); Kia Corporation, Seoul (KR)

(72) Inventor: Jung Sae YIM, Hwaseong-si (KR)

(73) Assignees: Hyundai Motor Company, Seoul (KR); Kia Corporation, Seoul (KR)

(21) Appl. No.: 19/319,559

(22) Filed: Sep. 4, 2025

(30) Foreign Application Priority Data
Mar. 31, 2025 (KR) 10-2025-0041121

(51) Int. Cl. B60L 53/65; B60L 53/66; B60L 53/68; G06F 21/44; H04L 9/32

(52) U.S. Cl. CPC B60L 53/65; B60L 53/66; B60L 53/68; G06F 21/44; H04L 9/3242; H04L 9/3263

(57) ABSTRACT

A charger includes one or more processors and a storage medium storing a computer-readable instruction, wherein the one or more processors executing the computer-readable instruction are configured to receive a digital key including a plurality of certificates and a vehicle-specific MAC address, to transmit an authentication request based on the digital key and the vehicle-specific MAC address using an open application program interface (API), and to perform a charging process with a vehicle based on an authentication result in response to the authentication request being a success.

### CROSS-REFERENCE TO RELATED APPLICATIONS

The present application claims benefit of priority to Korean Patent Application No. 10-2025-0041121 filed on March 31, 2025, the present disclosure of which is incorporated herein by reference in its entirety.

### TECHNICAL FIELD

The present disclosure relates to a charger, a vehicle, and an authentication server for performing charging authentication using a digital key.

It is to be noted that the contents described in the present section merely provide background information on the present disclosure and do not constitute related art.

Currently, chargers perform authentication using external identity management (EIM) which is an external authentication method, or plug and charge (PnC) which is an automatic authentication method based on a certificate. Thereamong, EIM is a method of authenticating using a separate method for each manufacturer, such as quick response (QR) authentication or member authentication, and PnC is a method of authenticating based on a public key infrastructure (PKI) certificate installed in vehicles.

EIM is very inconvenient for customers because customers have to carry a membership card of each charger manufacturer, register as a member with a charger manufacturer, or perform QR authentication due to different authentication methods for each charger manufacturer.

An aspect of the present disclosure is to provide a charger, a vehicle, and an authentication server for performing charging authentication using a digital key, configured for initiating charging without a separate authentication procedure and allowing even a charger not supporting PKI certificate-based PnC of the ISO 15118-2 standard may implement charging like PnC.

According to an aspect of the present disclosure, a charger includes: one or more processors; and a storage medium storing a computer-readable instruction, wherein the one or more processors executing the computer-readable instruction are configured to receive a digital key including a plurality of certificates and a vehicle-specific MAC address, to transmit an authentication request based on the digital key and the vehicle-specific MAC address using an open application program interface (API), and to perform a charging process with a vehicle based on an authentication result in response to the authentication request being a success.

The one or more processors may be configured to determine whether a mobile terminal storing the digital key is within a preset distance from the charger and to transmit information on the charger to the mobile terminal based on a distance to the mobile terminal being within the preset distance.

The one or more processors may be configured to transmit the authentication request when both a request for the vehicle-specific MAC address and the vehicle-specific MAC address are received, and to transmit the request for the vehicle-specific MAC address to the vehicle based on the digital key being received.

The plurality of certificates may include a first certificate for ensuring that a mobile terminal MT using the digital key is provided by a correct manufacturer, a second certificate

for ensuring that the mobile terminal MT has unique digital key authentication information, and a third certificate for ensuring the validity of the digital key itself.

The information on the charger includes a number of the charger available for charging and a random number.

According to another aspect of the present disclosure, a vehicle includes: one or more processors; and a storage medium storing a computer-readable instruction, wherein, when the computer-readable instruction is executed by the one or more processors, the one or more processors may be configured to transmit a vehicle-specific MAC address, to receive an authentication result, a result of performing an authentication procedure for an owner of a vehicle and the vehicle, according to an authentication request based on the vehicle-specific MAC address and a plurality of certificates included in a digital key of a mobile terminal, the authentication request using an open application program interface (API), and to perform a charging process with a charger based on the authentication result being a success.

The open API may be an API provided by a manufacturer of the vehicle.

The plurality of certificates may include a first certificate for ensuring that a mobile terminal MT using the digital key may be provided by a correct manufacturer, a second certificate for ensuring that the mobile terminal MT has unique digital key authentication information, and a third certificate for ensuring the validity of the digital key itself.

The authentication procedure may be a procedure for authenticating the vehicle by authenticating an owner of the vehicle through chain verification of each of the plurality of certificates and determining whether the vehicle-specific MAC address matches a vehicle identifier included in the certificates.

According to another aspect of the present disclosure, an authentication server includes: one or more processors; and a storage medium storing a computer-readable instruction, wherein, when the computer-readable instruction may be executed by the one or more processors, the one or more processors may be configured to receive an authentication request based on a digital key including a plurality of certificates and a vehicle-specific MAC address using an open application program interface (API), to perform, in response to the authentication request, an authentication procedure for an owner of a vehicle and the vehicle based on the plurality of certificates included in the digital key and the vehicle-specific MAC address, and to transmit an authentication result as a result of performing the authentication procedure to a charger.

The open API may be an API provided by the authentication server, and the authentication server may be a server provided by a vehicle manufacturer.

The one or more processors may be configured to authenticate the owner of the vehicle through chain verification of each of the plurality of certificates and determining whether the vehicle-specific MAC address matches a vehicle identifier included in the certificates.

The plurality of certificates may include a first certificate for ensuring that a mobile terminal MT using the digital key may be provided by a correct manufacturer, a second certificate for ensuring that the mobile terminal MT has unique digital key authentication information, and a third certificate for ensuring the validity of the digital key itself.

### BRIEF DESCRIPTION OF DRAWINGS

The other aspects, features, and advantages of the present disclosure will be more clearly understood from the following detailed description, taken in conjunction with the accompanying drawings, in which:

FIG. 1 is a diagram illustrating a charging authentication system using a digital key according to an exemplary embodiment of the present disclosure;

FIG. 2 is a flowchart explaining a charging authentication method using a digital key according to an exemplary embodiment of the present disclosure;

FIG. 3 is a flowchart further specifying the charging authentication method using a digital key illustrated in FIG. 2; and

FIG. 4 is a block diagram of a computing device that may fully or partially implement controllers of a charging authentication system using a digital key according to an exemplary embodiment of the present disclosure.

### DETAILED DESCRIPTION

Hereinafter, exemplary embodiments of the present disclosure are described with reference to the accompanying drawings. The following description is provided to aid in the comprehensive understanding of methods, devices, and/or systems disclosed in the particularities. However, the following description is merely exemplary and not provided to limit the present disclosure.

In the following description of the present disclosure, a detailed description of known functions and configurations incorporated herein will be omitted when it would render the subject matter of the present disclosure unclear. The terms used in the present specification are defined in consideration of functions used in the present disclosure, and may be changed according to the intent or conventionally used methods of clients, operators, and users. Accordingly, definitions of the terms should be understood based on the entire description of the present specification. Terms used in the following description are merely provided to describe embodiments of the present disclosure and are not intended to be limiting of the inventive concept. As used herein, the singular forms “a,” “an” and “the” are intended to include the plural forms as well, unless the context clearly indicates otherwise. It will be further understood that the terms “comprises” or “has” when used in the present specification, specify the presence of stated features, integers, steps, operations, elements, or a portion or combination thereof, but do not preclude the presence or addition of one or more other features, integers, steps, operations, elements, or a portion or combination thereof.

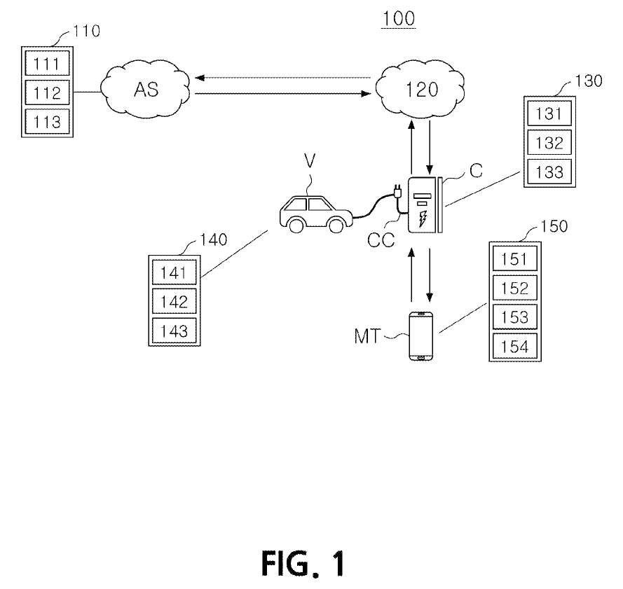

FIG. 1 is a diagram illustrating a charging authentication system using a digital key according to an exemplary embodiment of the present disclosure.

As illustrated in FIG. 1, a charging authentication system 100 using a digital key may include an authentication server AS including an authentication controller 110, a charger server 120, a charger C including a first charging controller 130, a vehicle V including a second charging controller 140, and a mobile terminal MT including a terminal controller 150. In an exemplary embodiment of the present disclosure, the charger server 120 simply transmits data, and thus a separate internal block is not illustrated, but the charger server 120 may have the same internal block as those of other controllers 110, 130, and 140.

Furthermore, although the charger C is illustrated as transmitting and receiving various data through the charger server 120, the charger C may transmit and receive data directly to or from the authentication server AS without going through the charger server 120. Furthermore, the charger server 120 and the authentication server AS may be configured as a single server.

The controllers 110, 120, 130, 140, and 150 described above may include a processor (e.g., a computer, a microprocessor, a CPU, an ASIC, a logic circuit, etc.) and a memory storing software instructions providing various functions when executed by the processor. Here, the processor and the memory may be implemented as separate semiconductor circuits. Alternatively, the processor and the memory may be implemented as a single integrated semiconductor circuit. There may be one or more processors.

First, the authentication controller 110 disposed in the authentication server AS may include a communication unit 111, an authentication processor 112, and a storage unit 113.

The communication unit 111 may transmit and receive various data to or from the charger server 120 under the control of the authentication processor 112.

The authentication processor 112 may receive an authentication request (DigitalKeyAuthReq) from the charger C using an open application program interface (API).

Thereafter, in response to the authentication request (DigitalKeyAuthReq), the authentication processor 112 may perform an authentication procedure for authenticating an owner of the vehicle V and the vehicle V based on a plurality of certificates included in the digital key and a vehicle-specific MAC address may be performed, and an authentication result (VehicleServerAuthRes), which is a result of performing the authentication procedure, may be transmitted to the charger C.

In an exemplary embodiment of the present disclosure, the digital key is digital data providing authentication information to access or control the vehicle V or the charger C and may include a plurality of certificates.

Furthermore, the plurality of certificates described above may include, for example, a first certificate (Device OEM CA Certificate) for ensuring that a mobile terminal MT using the digital key is provided by a correct manufacturer, a second certificate (Instance CA Certificate) for ensuring that the mobile terminal MT has unique digital key authentication information, and a third certificate (DigitalKey Certificate) for ensuring the validity of the digital key itself.

Here, the first certificate (Device OEM CA Certificate) is a top-level root certificate of the PKI of the mobile terminal MT, and the second certificate (Instance CA Certificate) described above is a PKI certificate of the mobile terminal Secure Element area signed by a device OEM (Device Original Equipment Manufacturer). Furthermore, the third certificate (DigitalKey Certificate) described above may be a PKI certificate of a digital key signed by an instance.

Furthermore, the aforementioned open API is an API provided by the authentication server AS, and the authentication server AS may be a server provided by a manufacturer of the vehicle V.

Furthermore, the vehicle-specific MAC address may be a unique identifier assigned to a network device within the vehicle V.

The authentication processor 112 may perform the authentication procedure as follows. That is, the authentication processor 112 may authenticate the owner of the vehicle V through chain verification of each of the plurality of certificates (Device OEM CA Certificate, Instance CA Certificate, DigitalKey Certificate) and may authenticate the vehicle V by determining whether the vehicle-specific MAC address matches a vehicle identifier included in the certificate. In the present manner, according to an exemplary embodiment of the present disclosure, the presence of the vehicle is confirmed by the MAC address, and the user's identity is confirmed by the digital key, so that security may be further strengthened.

Meanwhile, the storage unit 113 may store programs, etc. for implementing various functions performed by the authentication processor 112 described above.

Meanwhile, the charger server 120 may transmit various data between the authentication server AS and the charger C. That is, the charger server 120 may receive an authentication request (DigitalKeyAuthReq) from the charger C and transmit the same to the authentication server AS, and receive an authentication result (VehicleServerAuthRes) from the authentication server AS and transmit the same to the charger C. The charger server 120 described above is illustrated separately from the authentication server AS, but the charger server 120 may be integrated with the authentication server AS to be configured as one server or omitted, as described above.

The first charging controller 130 disposed in the charger C may include a communication unit 131, a first charging processor 132, and a storage unit 133.

The communication unit 131 may transmit and receive various data between the charger server 120, the vehicle V, and the mobile terminal MT under the control of the first charging processor 132.

The first charging processor 132 may receive a digital key from the mobile terminal MT, transmit a request for the vehicle-specific MAC address to the vehicle V, receive the vehicle-specific MAC address from the vehicle V, and then transmit an authentication request (DigitalKeyAuthReq) based on the digital key and the MAC address of the vehicle to the charger server 120 using the open API. According to another exemplary embodiment of the present disclosure, the first charging processor 132 may also transmit the request for a vehicle-specific MAC address to the vehicle V when the charging connector CC is connected.

Furthermore, the first charging processor 132 is configured to determine whether the mobile terminal MT storing the digital key is adjacent to the charger C, for example, whether the mobile terminal MT is within a preset distance (e.g., 5 meters) from the charger C, and when the distance from the charger C to the mobile terminal MT is within the preset distance, information (ChargerInfo) of the charger C may be transmitted to the mobile terminal MT. Here, the information (ChargerInfo) of the charger C may include, for example, the number of the charger configured for performing charging, a random number, or the like. Here, the random number is for strengthening security and session identification.

Furthermore, the first charging processor 132 receives an authentication result (VehicleServerAuthRes) from the charger server 120, and if the authentication result (VehicleServerAuthRes) is a successful authentication, the charging process may be performed with the vehicle V.

The storage unit 133 may store programs, etc. for implementing various functions performed by the first charging processor 132 described above.

Meanwhile, the second charging controller 140 disposed in the vehicle V may include a communication unit 141, a second charging processor 142, and a storage unit 143. In an exemplary embodiment of the present disclosure, the vehicle V may be an electric vehicle which may be charged by the charger C.

The communication unit 141 may transmit and receive various data to or from the charger C under the control of the second charging processor 142.

The second charging processor 142 may receive a request for a vehicle-specific MAC address from the charger C, and in response thereto, may transmit the vehicle-specific MAC address to the charger C. Thereafter, the second charging processor 142 may perform a charging process with the vehicle V according to the authentication result (VehicleServerAuthRes).

The storage unit 143 may store programs, etc. For implementing various functions performed by the second charging processor 142 described above.

Finally, the terminal controller 150 disposed in the mobile terminal MT may include a communication unit 151, a terminal processor 152, a storage unit 153, and an input/output unit 154.

The communication unit 151 may transmit and receive various data to or from the charger C under the control of the terminal processor 152.

The terminal processor 152 may receive information (ChargerInfo) of the charger C from the charger C, and in response thereto, may output a notification inquiring about the user's charging intention through the input/output unit 154 described below. The notification inquiring about the charging intention may be in a form of, for example, "Do you want to charge at CP2?"

Furthermore, the terminal processor 152 may transmit a digital key to the charger C when the user's charging intention is input (e.g., when an OK button is clicked) based on the notification output through the input/output unit 154. Bluetooth Low Energy (BLE), Near Field Communication (NFC), Wi-Fi or Ultra-Wideband (UWB) technology may be used to transmit the digital key.

The storage unit 153 stores the digital key including the plurality of certificates described above and may store programs for implementing various functions performed by the terminal processor 152 described above.

The input/output unit 154 may output a notification inquiring a user's charging intention under the control of the terminal processor 152 or may receive the user's charging intention.

As described above, according to an exemplary embodiment of the present disclosure, when the mobile terminal is in proximity, charging authentication may be automatically performed through the digital key and the vehicle-specific MAC address stored in the mobile terminal, so charging may be initiated without a separate authentication procedure, and since the presence of the vehicle is identified by the MAC address and the user's identity is identified by the digital key, security may be further strengthened.

Furthermore, according to an exemplary embodiment of the present disclosure, since authentication is performed through the open API provided by a vehicle manufacturer, even a charger not supporting PKI certificate-based PnC of the ISO 15118-2 standard may implement charging like PnC.

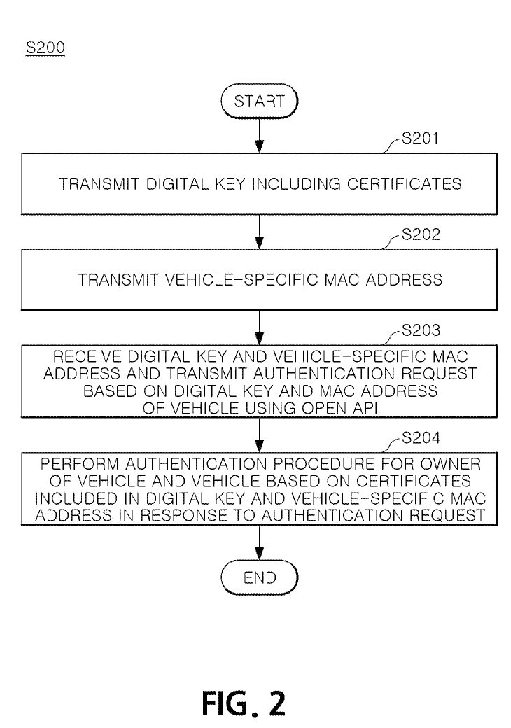

FIG. 2 is a flowchart illustrating a charging authentication method using a digital key according to an exemplary embodiment of the present disclosure.

A charging authentication method (S200) using a digital key according to an exemplary embodiment of the present disclosure may be started by transmitting a digital key including a plurality of certificates from a mobile terminal MT to a vehicle V (S201).

Thereafter, the vehicle V may transmit a vehicle-specific MAC address to the charger C (S202).

Next, the charger C may receive a digital key and a vehicle-specific MAC address and transmit an authentication request (DigitalKeyAuthReq) based on the digital key and the MAC address of the vehicle to the authentication server AS using the open API (S203).

Finally, in response to the authentication request (DigitalKeyAuthReq), the authentication server AS may authenticate the owner of the vehicle and the vehicle based on the plurality of certificates included in the digital key and the vehicle-specific MAC address and transmit an authentication result (VehicleServerAuthRes) to the charger C (S204). If the authentication result (VehicleServerAuthRes) is a successful authentication, a charging process between the charger C and the vehicle V may be performed.

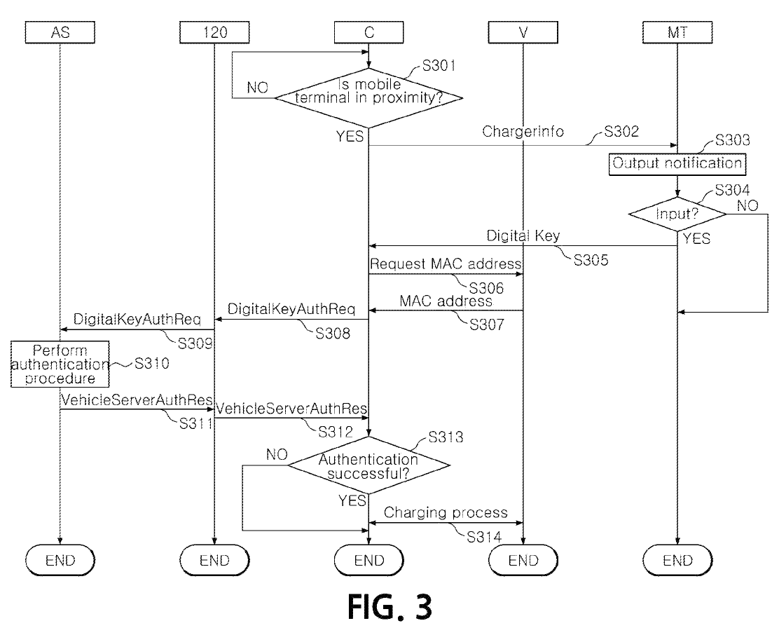

FIG. 3 is a flowchart illustrating a charging authentication method using a digital key illustrated in FIG. 2.

Hereinafter, a charging authentication method (S300) using a digital key according to an exemplary embodiment of the present disclosure will be described with reference to FIGS. 1 and 3. However, for the sake of simplification of the present disclosure, redundant descriptions as those described above with reference to FIG. 1 and FIG. 2 will be omitted.

As illustrated in FIGS. 1 and 3, the charging authentication method (S300) using a digital key according to an exemplary embodiment of the present disclosure may be initiated by determining whether the mobile terminal MT storing a digital key is adjacent to the charger C, for example, whether the mobile terminal MT is within a preset distance (e.g., 5 meters) from the charger C (S301).

When the distance from the charger C to the mobile terminal MT is within the preset distance, the charger C may transmit information (ChargerInfo) of the charger C to the mobile terminal MT (S302). Here, the information (ChargerInfo) of the charger C may include, for example, the number of the charger available for charging and a random number, and as described above, the random number is intended to enhance security and session identification.

Thereafter, the mobile terminal MT may output a notification inquiring about the user's charging intention (S303). The notification inquiring about the charging intention may be in a form of, for example, "Do you want to charge at CP2?"

Furthermore, the mobile terminal MT is configured to determine whether the user's charging intention is input (e.g., when the OK button is clicked) based on an output notification (S304), and when the user's charging intention is input, the digital key may be transmitted to the charger C (S305).

The charger C which has received the digital key transmits a request for a vehicle-specific MAC address to the vehicle V (S306), and in response thereto, the vehicle V may transmit the vehicle-specific MAC address to the charger C (S307).

Thereafter, the charger C may transmit an authentication request (DigitalKeyAuthReq) based on the digital key and the vehicle's MAC address to the authentication server AS through the charger server 120 using the open API (S308 and S309).

Thereafter, in response to the authentication request (DigitalKeyAuthReq), the authentication server AS may perform an authentication procedure for authenticating the owner of the vehicle V and the vehicle V based on the plurality of certificates included in the digital key and the vehicle-specific MAC address (S310) and transmit an authentication result (VehicleServerAuthRes), which is a result of performing the authentication procedure, to the charger C via the charger server 120 (S311 and S312).

In an exemplary embodiment of the present disclosure, the digital key is digital data providing authentication information to access or control the vehicle V or the charger C, and as described above, the digital key may include a plurality of certificates.

Furthermore, the plurality of certificates may include, for example, the first certificate (Device OEM CA Certificate) for ensuring that the mobile terminal MT using a digital key is provided by the correct manufacturer, the second certificate (Instance CA Certificate) for ensuring that the mobile terminal MT has unique digital key authentication information, and the third certificate (DigitalKey Certificate) for ensuring the validity of the digital key itself.

Here, the first certificate (Device OEM CA Certificate) is a top-level root certificate of the PKI of the mobile terminal MT, and the second certificate (Instance CA Certificate) described above is a PKI certificate of the mobile terminal secure element area signed by the device OEM (Device Original Equipment Manufacturer). Furthermore, the third certificate (DigitalKey Certificate) described above may be a PKI certificate of a digital key signed by an instance.

Furthermore, as described above, the open API described above is an API provided by the authentication server AS, and here, the authentication server AS may be a server provided by the manufacturer of the vehicle V as described above.

Thereafter, the charger C may be configured to determine whether the authentication result (VehicleServerAuthRes) received from the charger server 120 is a success (S313), and if the authentication result (VehicleServerAuthRes) is a success, the charging process may be performed with the vehicle V (S314).

As described above, according to an exemplary embodiment of the present disclosure, when the mobile terminal is in proximity, charging authentication is automatically performed through the digital key stored in the mobile terminal and the vehicle-specific MAC address, so that charging may be initiated without a separate authentication procedure, and since the presence of the vehicle is identified through the MAC address and the user's identity is identified through the digital key, security may be further strengthened.

Furthermore, according to an exemplary embodiment of the present disclosure, since authentication is performed through the open API provided by the vehicle manufacturer, even a charger not supporting PKI certificate-based PnC of the ISO 15118-2 standard may implement charging like PnC.

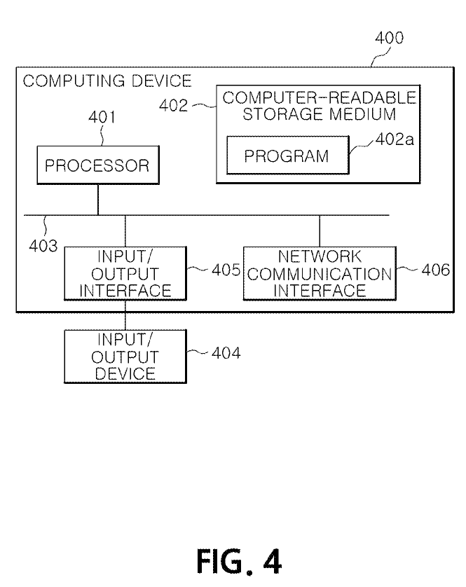

FIG. 4 is a block diagram of a computing device configured for fully or partially implementing the controllers 110, 120, 130, 140, and 150 of a charging authentication system using a digital key according to an exemplary embodiment of the present disclosure.

As illustrated in FIG. 4, a computing device 400 includes at least one processor 401, a computer-readable storage medium 402, and a communication bus 403.

The processor 401 may cause the computing device 400 to operate according to the exemplary embodiments of the present disclosure described above. For example, the processor 401 may execute one or more programs stored in the computer-readable storage medium 402. The one or more programs may include one or more computer-executable instructions, which, when executed by the processor 401, may be configured to cause the computing device 400 to perform operations according to the embodiments.

The computer-readable storage medium 402 is configured to store computer-executable instructions, program code, program data, and/or other suitable forms of information. A program 402a stored in the computer-readable storage medium 402 includes a set of instructions executable by the processor 401. In an exemplary embodiment of the present disclosure, the computer-readable storage medium 402 may be memory (volatile memory, such as random access memory, nonvolatile memory, or a suitable combination thereof), one or more magnetic disk storage devices, optical disk storage devices, flash memory devices, or any other forms of storage medium that may be accessed by the computing device 400 and store desired information, or a suitable combination thereof.

The communication bus 403 interconnects various other components of the computing device 400, including the processor 401 and the computer-readable storage medium 402.

The computing device 400 may also include one or more input/output interfaces 405 providing an interface for one or more input/output devices 404, and one or more network communication interfaces 406. The input/output interface 405 and the network communication interface 406 are connected to the communication bus 403. The network may be one of a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), or another cellular network. Alternatively, the network may be one of Ultra-Wideband (UWB), Bluetooth Low Energy (BLE), Near Field Communication (NFC), or the like.

Meanwhile, the input/output device 404 may be connected to other components of the computing device 400 via the input/output interface 405. For example, the input/output device 404 may include an input device, such as a pointing device (such as a mouse or trackpad), a keyboard, a touch input device (such as a touchpad or a touchscreen), a voice or sound input device, various types of sensor devices and/or imaging devices, and/or an output device, such as a display device, a printer, a speaker, and/or a network card. For example, the input/output device 404 may be included in the computing device 400 as a component forming the computing device 400 or may be connected to the computing device 400 as a separate device distinct from the computing device 400.

According to an exemplary embodiment of the present disclosure, when the mobile terminal is in proximity, charging authentication is automatically performed through a digital key stored in the mobile terminal and a vehicle-specific MAC address, so that charging may be initiated without a separate authentication procedure, and since the presence of the vehicle is identified through the MAC address and user authentication is checked through the digital key, security may be further strengthened.

Furthermore, according to an exemplary embodiment of the present disclosure, since authentication is performed through the open API provided by a vehicle manufacturer, even a charger not supporting PKI certificate-based PnC of the ISO 15118-2 standard may implement charging like PnC.

Meanwhile, the exemplary embodiments of the present disclosure may include a program for performing the methods described in the present specification on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of computer-readable recording medium include magnetic medium, such as hard disks, floppy disks, and magnetic tapes, optical recording medium, such as CD-ROMs, DVDs, and hardware devices configured to store and perform program instructions, such as ROM, RAM, flash memory, etc. Examples of the program may include not only machine language code, such as that generated by a compiler, but also high-level language code that may be executed by a computer using an interpreter or the like.

While embodiments have been shown and described above, it will be apparent to those skilled in the art that modifications and variations could be made without departing from the scope of the present disclosure as defined by the appended claims.

What is claimed is:

1. A charger comprising:
one or more processors; and
a storage medium storing a computer-readable instruction,
wherein the one or more processors executing the computer-readable instruction are configured to:
receive a digital key including a plurality of certificates and a vehicle-specific MAC address,
transmit an authentication request based on the digital key and the vehicle-specific MAC address using an open application program interface (API), and
perform a charging process with a vehicle based on an authentication result in response to the authentication request being a success.

2. The charger of claim 1, wherein the one or more processors are further configured to determine whether a mobile terminal storing the digital key is within a preset distance from the charger and to transmit information on the charger to the mobile terminal based on a distance to the mobile terminal being within the preset distance.

3. The charger of claim 1, wherein the one or more processors are further configured to transmit the authentication request based on both a request for the vehicle-specific MAC address and the vehicle-specific MAC address being received, and to transmit the request for the vehicle-specific MAC address to the vehicle based on the digital key being received.

4. The charger of claim 1, wherein the plurality of certificates include:
a first certificate for ensuring that a mobile terminal using the digital key is provided by a correct manufacturer;
a second certificate for ensuring that the mobile terminal has unique digital key authentication information; and
a third certificate for ensuring a validity of the digital key itself.

5. The charger of claim 1, wherein the information on the charger includes a number of the charger available for charging and a random number.

6. The charger of claim 1, wherein the one or more processors of the charger receives the vehicle-specific MAC address from the vehicle responding to the charger’s request of MAC address.

7. The charger of claim 1, wherein the one or more processors of the charger transmits the authentication request to an authentication server configured to perform, in response to the authentication request, an authentication procedure for an owner of the vehicle and the vehicle based on the plurality of certificates included in the digital key and the vehicle-specific MAC address.

8. A vehicle comprising:
one or more processors; and
a storage medium storing a computer-readable instruction,
wherein the one or more processors executing the computer-readable instruction are configured to:
transmit a vehicle-specific MAC address,
receive an authentication result, a result of performing an authentication procedure for an owner of a vehicle and the vehicle, according to an authentication request based on the vehicle-specific MAC address and a plurality of certificates included in a digital key of a mobile terminal, the authentication request using an open application program interface (API), and
perform a charging process with a charger based on the authentication result being a success.

9. The vehicle of claim 8, wherein the open API is an API provided by a manufacturer of the vehicle.

10. The vehicle of claim 8, wherein the plurality of certificates include:
a first certificate for ensuring that the mobile terminal using the digital key is provided by a correct manufacturer;
a second certificate for ensuring that the mobile terminal has unique digital key authentication information; and
a third certificate for ensuring a validity of the digital key itself.

11. The vehicle of claim 8, wherein the authentication procedure is a procedure for authenticating the vehicle by authenticating an owner of the vehicle through chain verification of the plurality of certificates and determining whether the vehicle-specific MAC address matches a vehicle identifier included in the certificates.

12. The vehicle of claim 8, wherein the one or more processors of the vehicle transmits the vehicle-specific MAC address to the charger in response to the charger’s request of MAC address.

13. An authentication server comprising:
one or more processors; and
a storage medium storing a computer-readable instruction,
wherein the one or more processors executing the computer-readable instruction are configured to:
receive an authentication request based on a digital key including a plurality of certificates and a vehicle-specific MAC address using an open application program interface (API),
perform, in response to the authentication request, an authentication procedure for an owner of a vehicle and the vehicle based on the plurality of certificates included in the digital key and the vehicle-specific MAC address, and
transmit an authentication result as a result of performing the authentication procedure to a charger.

14. The authentication server of claim 13, wherein the open API is an API provided by the authentication server, and the authentication server is a server provided by a vehicle manufacturer.

15. The authentication server of claim 13, wherein the one or more processors are further configured to authenticate the owner of the vehicle through chain verification of each of the plurality of certificates and determining whether the vehicle-specific MAC address matches a vehicle identifier included in the certificates.

16. The authentication server of claim 13, wherein the plurality of certificates include a first certificate for ensuring that a mobile terminal using the digital key is provided by a correct manufacturer, a second certificate for ensuring that the mobile terminal has unique digital key authentication information, and a third certificate for ensuring a validity of the digital key itself.

17. The authentication server of claim 13, wherein the one or more processors of the authentication server receive the authentication request from the charger.
